(19) United States
(12) Patent Application Publication
(10) Pub. No.: US 2015/0317876 A1
(43) Pub. Date: Nov. 5, 2015

(54) Multi-Player Lottery Game with Increased Revenue Generation Potential

(71) Applicant: Scientific Games International, Inc., Newark, DE (US)

(72) Inventor: Scott B. Garrison, Duluth, GA (US)

(73) Assignee: Scientific Games International, Inc., Newark, DE (US)

(21) Appl. No.: 14/268,011

(22) Filed: May 2, 2014

(51) Int. Cl. G07F 17/32

(52) U.S. Cl. CPC G07F 17/3244; G07F 17/3272

(57) ABSTRACT

A method is provided for a network-based multi-player game wherein a plurality of players access a website via a network enabled device and join a multi-player game hosted by a game provider. The players are assigned individual virtual game plays and a play order is assigned to the plurality of players, wherein the players take turns revealing an aspect of their respective game play according to the assigned play order. Upon a first one of the players revealing a winning game outcome of their game play during one of their respective turns, further play of the multi-player game stops and the first winning player is credited with the prize award assigned to their game play. The first winning player is given the option to pay an additional wager amount for transfer at least one of the remaining game plays for further play by the first winning player.

### BACKGROUND

A primary function of many jurisdictional-based lotteries is to raise money for various civic or governmental purposes, such as education, scholarships, parks/recreation, highway construction/repair, and so forth. For conventional ticket-based lottery games, the maximum revenue that can be generated is from the single sale of each ticket. This revenue is used to set the expected value (EV) of the game, probabilities, and payouts. Traditional scratch-off and on-line games have evolved over decades, supplying increasing revenue year after year. However, the sales curves associated with traditional games seem to be flattening out. Consequently, both lotteries and their service providers are presently searching for new forms of gaming that will sustain or increase revenue for the civic or governmental purposes, while also providing more exciting and entertaining games to the public.

Accordingly, a system and associated method of lottery games wherein the sale of a ticket at an initial wager amount can be leveraged into additional revenue would be extremely beneficial to the lottery jurisdictions. Gaming establishments, such as casinos, would also generate more profit from ticket based games wherein the tickets can be leveraged into revenue beyond the initial wager amount.

### SUMMARY OF THE INVENTION

Objects and advantages of the invention will be set forth in part in the following description, or may be obvious from the description, or may be learned through practice of the invention.

The industry is continually seeking means to enhance the gaming experience for players and increase participation in the games and, in this regard, is turning to Internet-enabled games. The present invention combines aspects of traditional lottery games with the Internet and social media networks to provide a unique and entertaining multi-player game that also enables revenue generation beyond the initial sale of lottery tickets or individual game plays.

The present invention provides a new game system and methodology that create a more interactive and social experience for the players. The methods and systems are not limited to any particular type of base game, and may be implemented with any manner of known, popular, game, particularly lottery games, or new games.

It should be appreciated that although aspects of the present invention are explained herein with reference to lottery games, the invention is not limited to lotteries. The invention is applicable to and has usefulness in other gaming environments as well, such as casino-related gaming environments.

In a particular embodiment, a computer-enabled method is provided for implementing a network-based, multi-player game. The method includes providing for a plurality of players to access a website via a network enabled device and join a multi-player game hosted over the network by a game provider via a host computer. For example, the players may access the website via a personal network enabled device, such as a PC, PDA, mobile cellular device, or any other of type of device that allows the player to communicate directly with the host computer via a network, such as the Internet, a WAN (wide area network), LAN (local area network), and the like. With any one of these personal devices, the player may be directed to download gaming software (permanent or temporary) to their device that enables the player to perform all functions needed to play the game, from initial wagering to final play of the game plays, as described below.

Continuing with the method, upon commencement of the game, each of the plurality of players is assigned an individual virtual game play. The prize award and game outcome of each respective game play are hidden from the players.

It should be understood that the term “game play” is used herein to encompass any type of simulated play of a game, and that the invention is not limited to any particular type of game play. For example, the game plays may simulate any well-known lottery or casino game format, such as a slot machine theme, card game theme, and so forth. The game play may simulate popular television games, such as The Wheel of Fortune™, wherein contestants take turns solving a word puzzle. In a particular embodiment, the game plays emulate scratch-off lottery tickets, as described in greater detail below.

A play order is assigned to the plurality of players. This play order dictates the order in which the players will take turns revealing an aspect of the outcome of their respective game play, for example an indication of the progression of the game towards a winning outcome. For example, the first player in the play order will take a reveal step, such as uncovering a hidden game piece or indicia, followed by the second player in the play order, and so forth.

Eventually, one of the players will reveal a winning game outcome of their game play during one of their respective turns, thus becoming the “first winning player.” At this point, further play of the game is ceased and the first winning player is credited with the prize award assigned to their respective game card. The game plays of one or more of the other players are, at this time, in a partially revealed state in which the win/loss outcome of the game play cannot be determined without further play of the game play. The first winning player is presented with the option to pay an additional wager amount for transfer of at least one of the partially revealed remaining game plays for further play by the first winning player. This step may include providing the first winning player with a preview of the remaining game plays in their partially revealed state so that the first winning player is fully aware of the state of the remaining game plays prior to exercising the option. This option may be for one, all, or any combination of the remaining game plays. Once the additional wager is tendered, the remaining game plays are transferred to the first winning player for completion. This transfer may take place by the remaining game plays appearing on the first winning player's screen in their respective partially revealed state with instructions on how to complete the game plays.

If any of the remaining game plays purchased by the first winning player results in a prize award, then such award is credited to the first winning player.

It should be appreciated that the prize award in any one of the remaining game plays is not restricted or limited by the prize award of the first winning player's game play. For example, the remaining game play prize awards may be greater than the first winning player's initial prize award.

In still a further embodiment, the possibility exists that at least one of the remaining game plays includes a hidden “forfeit” game piece or other type of icon that, if revealed by the first winning player upon completing play or the game, results in the first winning player forfeiting all or a portion the player's prize award. For example, the forfeit game piece may result in loss of the first winning player's initial prize award, or forfeiture of the additional prize awards, or forfeiture of both the initial prize and award and the additional prize awards (or a portion of either or both prize awards).

It should be appreciated that the unique gaming methodology provides significant and unique advantages to the both the players and the game provider. For the player, the game provides additional entertainment and wagering options. The player is presented with the opportunity to finish the game plays started by the other players with the thrill of potentially winning additional prizes. A degree of risk (which is enticing to some players) is also introduced if there is no guarantee that the remaining game plays include an additional award but, or a guarantee of a minimum amount of such additional award. For example, in a particular variation, there may be a guaranteed additional award in one of the remaining, partially revealed game plays, with no promise as to the amount of such award. The player may simply be aware that such award may be from a token amount (e.g., $1) to a significant amount (e.g., $1,000). The player must then decide whether to spend the funds necessary to acquire the remaining game plays in the hopes that the guaranteed award is significant.

For the game provider, the game will generate additional revenue above and beyond the initial wager amount placed by the plurality of players for their initial game play. The game provider can design the game plays with a probability and payout to achieve the necessary design payout or “expected value” (EV) for the game as if no additional purchases of remaining game plays are made by the first winning player (because such additional purchases are an option, and not a requirement). For example, the body of game plays used for repeated plays of the multi-player game can be designed much like a run of instant lottery tickets (e.g., a run of 250,000 scratch off lottery tickets), wherein the results of the game plays and prize structure are predetermined to achieve a designed payout for the game (e.g., a design payout of 50% distributes one-half of the revenue generated by sale of the tickets as prize awards). The wager amounts generated by purchase of the remaining game plays by the first winning player constitute additional revenue for the game provider.

In an alternate embodiment, an anticipated amount of the additional revenue may be factored into the game payout, for example to achieve a payout required by the state or jurisdiction in which the multi-player game is conducted. However, this embodiment would lead to higher payouts for players, thus enticing more players to the game.

In a particularly unique embodiment, the network is the Internet and the plurality of players are members of an Internet social media group, such as Facebook™ or Twitter™. The plurality of players may be invited to participate in the multi-player game by an invite sent via the social media group. These invites may be initiated by any member of the group to any other member. The invite may identify the particular game (e.g., name of the game, features of the game, etc.) and include a link to the game provider's website where the game will ultimately be conducted. The player initiating the game may first contact the game provider via the website to establish the game, including number of players and any other parameters of the game. The game provider may then generate a game specific link to be passed on by the initiating player to the other invitees, or the game provider may contact the other players directly if identified by the initiating player.

The initiating player may be provided the option to set various game parameters or features that the other invitees must agree to prior to commencement of the game. These features may include, for example, wager amount (and prize potential), type/theme of game to be played, bonus features, and so forth.

In an alternate embodiment, the multi-player game is played via a local area network within a defined establishment or location. For example, the game may be conducted in a pub, bar or grill, restaurant, gaming house or casino, or any other type of establishment where the play of such games is authorized by local and jurisdictional laws. With this scenario, patrons of the gaming establishment may be invited to form a play group with other patrons via local area network enabled devices, such as game terminals located in the establishment. These terminals are in communication with the game provider via a server or any other hardware/software configuration. The players may enter the game as a group of friends or family, or the game provider may establish ongoing open games that are filled on a first-come basis by players at the gaming house or other location that may or may not know each other.

The game parameters can vary widely within the scope and spirit of the invention. In a particular embodiment, essentially all variables or aspects of the game may be predetermined by the game provider and cannot be influenced by actions of the players, although presentation of the game may appear to the players as if they are controlling the outcome of the game. For example, the win/loss status of each of the plurality of game plays may be predetermined by the game provider prior to commencement of the multi-player game. Regardless of the selection of game pieces or other progressive reveal steps made by the player, the outcome of the particular game play cannot be changed by any action taken by the player. The play order for the plurality of players may also be predetermined by the game provider prior to commencement of the multi-player game. For example, the game provider may define the first game play to be played and the subsequent order of the remaining game plays. With this embodiment, the first winning player may also be predetermined by the game provider prior to commencement of the multi-player game. For example, the game may be predetermined such that the third game play will be the “first winning player”, with the win being determined on the player's fourth reveal turn. It should be appreciated that any number of variables may be randomly and predetermined by the game provider.

In alternate embodiments, the players may be granted a certain degree of choice or control over the game variables. For example, each of the plurality of players may choose their respective game card from a collection of the game cards according to the play order. Although the play order was randomly and predetermined by the game provider, the players may select or assign the game cards amongst themselves. The game may be configured so that the players determine which game play wins and on which turn. Because all of the prizes assigned to all of the cards may eventually be awarded to one player, the game provider has ultimate control over the prize structure (and thus expected value (EV) of the overall game) and there is virtually no risk to the game provider in allowing the players to conduct and control the game outcome.

As mentioned, the particular type and/or theme of the multi-player game are not a limiting factor of the invention. In a particular embodiment, the virtual game plays are presented as game cards that simulate scratch-off lottery tickets of any desired theme. As is known, scratch-off lottery tickets typically have a plurality of game pieces (indicia) covered by a scratch-off layer, with the number, order, or other characteristic of the hidden game pieces determining the win/loss status and prize award for the game card. In an embodiment in accordance with the present invention, the plurality of players are each provided with a virtual scratch-off lottery ticket, with the players taking turns revealing game pieces on their respective game cards by simulated removal of the virtual scratch-off layer until the first winning player reveals a game piece during their respective turn that establishes their game card as the first winning game card. The collection of game cards may be the same type/theme of game, or may be different between the game cards. For example, one card may have a “poker” theme, while another has a “treasure hunt” theme. So long as the cards have the same number of hidden game pieces and prize structure, the multi-player game is not limited to the same type of game for each of the game cards.

In one embodiment, the outcome and prize award of the partially revealed remaining game cards are not revealed to the respective remaining players such that the remaining players do not know the potential prize award associated with their respective game card that was transferred to the first winning player. The identity of the first winning player may or may not be revealed to the remaining players.

However, in a particular embodiment that may engender a competitive spirit between the players, the outcome and prize award of the partially revealed game cards is revealed to the remaining players, for example after completion by the first winning player, such that the remaining players are aware of the prize award associated with their respective game card that was transferred to the first winning player. In a variation of this game, the outcome and prize awards of all of the remaining game cards are revealed to all of the remaining players so that each of the plurality of players knows the total value of all prize awards won by the first winning player and the prize award for each respective game card.

### BRIEF DESCRIPTION OF THE DRAWINGS

A full and enabling disclosure of the present subject matter, including the best mode thereof, directed to one of ordinary skill in the art, is set forth in the specification, which makes reference to various embodiments in the appended figures, in which:

FIG. 1 is a schematic view of an exemplary gaming system that may be used to implement various method embodiments in accordance with aspects of the present invention;

FIG. 2 is a graphical depiction of a plurality of players belonging to a social network playing a multi-player game in accordance with aspects of the present invention;

FIGS. 3A, 3B, and 3C are sequential flow diagrams illustrating various aspects of the gaming methodologies;

FIG. 4 is a graphical depiction of a system in accordance with aspects of the invention; and

FIG. 5 is a graphical depiction of an alternate system in accordance with aspects of the invention.

### DETAILED DESCRIPTION

Reference will now be made in detail to examples of the present invention, one or more embodiments of which are illustrated in the figures. Each example is provided by way of explanation of the invention, and not as a limitation of the invention. For instance, features illustrated or described with respect to one embodiment may be used with another embodiment to yield still a further embodiment. It is intended that the present application encompass these and other modifications and variations as come within the scope and spirit of the invention.

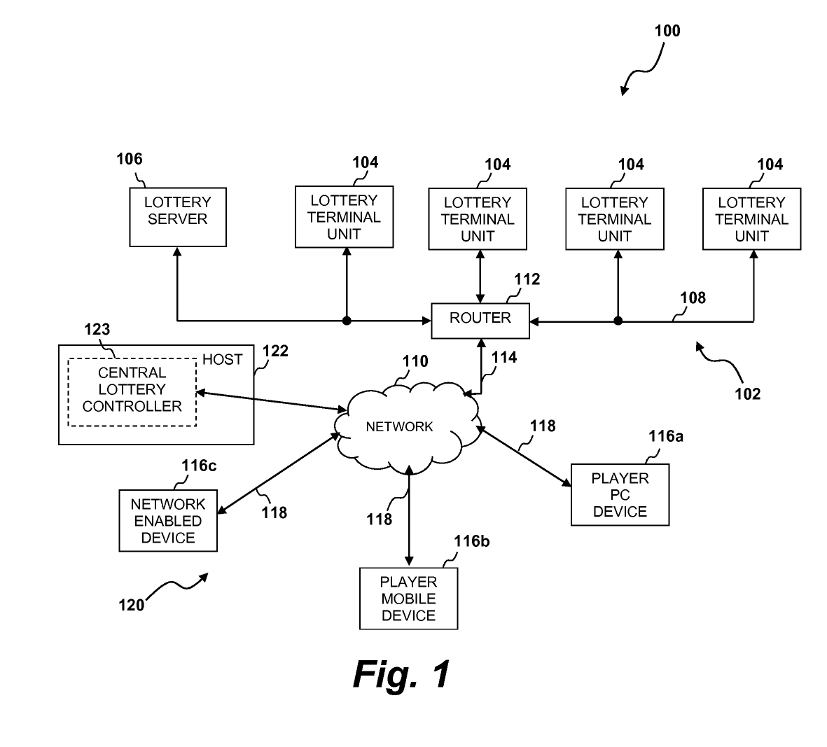

FIG. 1 is a diagram view of a representative gaming system 100 that may be used to practice aspects of the multi-player game in accordance with aspects of the invention. The system 100 includes a central system administered by the game provider, which may be a central lottery system hosted by a lottery game provider. The system 100 includes a host computer 122 with a central controller 123 for controlling aspects of the lottery or gaming system. It should be readily appreciated that the central controller may include an integrated server, or the host computer 122 may include any manner of periphery server or other hardware structure. The host computer 122 is configured to carry out the gaming functions associated with the multi-player games described herein.

The central system host computer 122 may be a single networked computer, or a series of interconnected computers having access to the network 110 via a gateway or other known networking system. Generally, the central host computer 122 may include a central controller 123 configured to manage, execute and control individual terminal units 104 (described in greater detail below), and to interface with the network enabled devices 116 for play of the multi-player games, as described herein. The central controller 123 may include a memory for storing gaming procedures and routines, a microprocessor (MP) for executing the stored programs, a random access memory (RAM) and an input/output (I/O) bus. These devices may be multiplexed together via a common bus, or may each be directly connected via dedicated communications lines, depending on the needs of the system 100.

The central controller 123 may be directly or indirectly connected through the I/O bus to any manner of peripheral devices such as storage devices, wireless adaptors, printers, and the like. In addition, a database (DB) may be communicatively connected to the central controller 123 and provide a data repository for the storage and correlation of information gathered from the individual terminal units 104, devices 116 or nodes 120. The information stored within the database may be information relating to individual players, games, or game card specific information.

The plurality of players may interface directly with the central lottery system. For example, the players may be provided with a link at the time of their initial invite into the multi-player game, and subsequently enter the game by accessing the central system directly via a network enabled device (for example, an Internet enabled PC or mobile device). For play of the games, the player may be directed to download gaming software to their PC or other network-enabled device that enables the player to perform all functions needed to play the multi-player games. In this regard, the network 100 may be configured for interacting with any manner of network enabled device used by players, such as the PC 116a, a mobile network enabled device 116b (such as a PDA or cellular phone), or any other type of remote network enabled device 116c, as depicted in FIG. 1. These other network enabled devices 116 may be directly connected to the network 110 through a plurality of direct network links 118, thereby eliminating the need for the bus, router, or other networking equipment.

It should also be appreciated that each of the network enabled devices 116 in this configuration may represent a lottery node 120 corresponding to a state or other jurisdictional lottery system operating within an individual state or region of states. The lottery nodes 120, in turn, may be directly connected and/or multiplexed to the network 110 via the direct network links 118. Further, the direct network links 118 may represent secure communications channels physically hardened against tampering and/or the communications may be encrypted to prevent unauthorized access to information transmitted thereon.

The players may be provided with a registration number or code (or other type of game-specific identifier) with their invitation for entry into an established game, or the link provided with the invitation may take the players directly to a specific game. In certain embodiments, the players may place their wager directly with the central system via their network enabled device, for example through an established player account.

In an alternate embodiment depicted within FIG. 1, the gaming system 100 may be implemented by a network layout 102 within a given establishment authorized by the state or other jurisdiction to conduct the games, such as a bar/grill, restaurant, gaming house, casino, and so forth. In this alternate configuration, a plurality of terminal units 104 may be provided to patrons as interactive terminals capable of playing a variety of different multi-player games. Terminal units 104 may be distributed throughout a single establishment and connected with a LAN, or throughout multiple sites and connected with a WAN. Further, the LAN and/or WAN connecting each of the terminal units 104 may include one or more separate and secure buses 108, routers 112, web servers 106, gateways and other networking equipment to provide continuous and/or redundant connectivity to the network 110. As discussed above, the network 110 may be communicatively connected to central host computers 122 and/or respective central controllers as well as associated databases to allow for implementation, storage, tracking and analysis of gaming and other features.

The terminal units 104 may be configured with any manner of hardware and software functionality to accept a player's entry and wager into a multi-player game, with the game being conducted via the player's interaction with the terminal 104. The terminal units 104 may also be configured for redeeming a player game card after completion of the multi-player game. For example, the terminals may issue a credit slip that the player uses to collect their prize award at a location remote form the terminal, for example at the establishment's cashier or an authorized lottery redemption center.

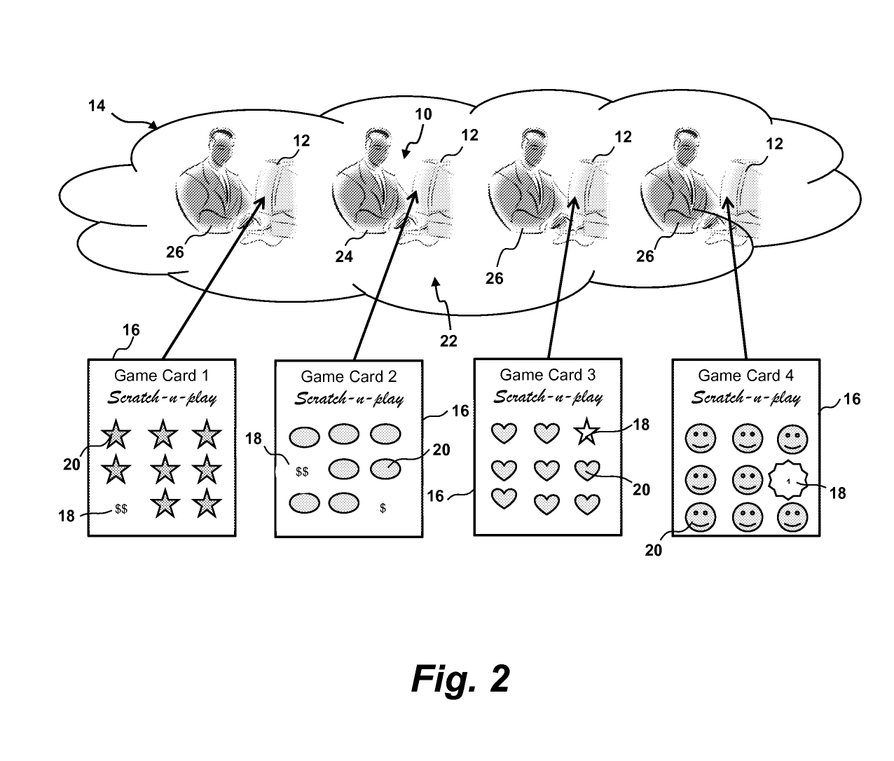

FIG. 2 is a graphical representation of an implementation of a network-based multi-player game in accordance with aspects of the present invention. The method includes providing for a plurality of players 10 to access a website via a respective network-enabled device 12 and join a multi-player game hosted over a network 14 by a game provider via a host computer (as explained in greater detail above with reference to FIG. 1). In the depiction of FIG. 2, four players 10 are participating in the multi-player game via respective personal network-enabled devices 12, such as a PC, PDA, mobile cellular device, or any other of type of device that allows the player 10 to communicate directly with the host computer via the network 14, which may be the Internet, a WAN (wide area network), a LAN (local area network), and the like. With any one of these personal devices 12, the player may be directed to download gaming software (permanent or temporary) to their device 12 that enables the player to perform all functions needed to play the game, from initial wagering to final play, as described below.

The players 10 may all be members of a social media group 22, such as Facebook™ or Twitter™. The plurality of players 10 may be invited to participate in the multi-player game by an invite sent via the social media group. These invites may be initiated by any member of the group to any other member. For example, one of the players 10 may be the initiating or requesting player 24 that sends invites to the invitee players 26. The invite may identify the particular game (e.g., name of the game, features of the game, etc.) and include a link to the game provider's website where the game will ultimately be conducted. The player 24 initiating the game may separately contact the game provider via the website to establish the game, including number of players and any other parameters of the game. The game provider may then generate a game specific link to be passed on by the initiating player to the other invitees. The game provider may also send the link directly to the identified players.

In certain non-limiting embodiments depicted in FIG. 2, the game plays of the multi-player game are card-based games. For example, the players 10 are assigned respective game cards 16 that simulate scratch-off lottery tickets having a plurality of game pieces 18 hidden under a virtual scratch-off layer 20. Once revealed, the game pieces 18 determine whether the game card 16 is a winning card and, if so, the prize award associated with the game card 16. Each of the game cards 16 may be for the same type of game—e.g., the same game theme, rules, and so forth. In an alternate embodiment as depicted in FIG. 2, the game cards 16 may be drawn to scratch-off games having different themes, rules for winning, and so forth. Generally, regardless of the game theme and rules for winning, each of the game cards 16 will have the same number of game pieces 18.

As discussed above, it should be appreciated that the present gaming methodologies are not limited to simulated scratch-off lottery tickets. The base game played by the plurality of players 10 may be any type of game wherein the players take turns according to an established play order to determine a first winning player. For example, the base game may include simulated spins of a game wheel wherein the first player to reach a defined point value is designated as the “first winning player.” Other games may be based on a virtual slot-machine wherein the first player to achieve a winning slots play is deemed the “first winning player.” The invention is not limited to the particular type of base game.

A play order is assigned to the plurality of players 10. This play order dictates the order in which the players10 will take turns revealing an aspect or progression of the game outcome of their respective game card 16. For example, the first player in the play order will take a reveal step, such as uncovering a hidden game piece18 or indicia by simulated removal of the scratch-off layer 20, followed by the second player in the play order, and so forth.

Referring again to FIG. 2, the game cards 16 depict that all of the players 10 have taken a first turn and revealed one game piece 18 on their respective card 16 according to a defined play order. Player 24 has taken an additional turn (he is the first in the play order) and revealed a second game piece 18 on his respective game card 16. The players 10 will continue to take turns until one of the game cards 16 is revealed to be a winner—regardless of the winning amount. At this point, the “first winning player” is determined.

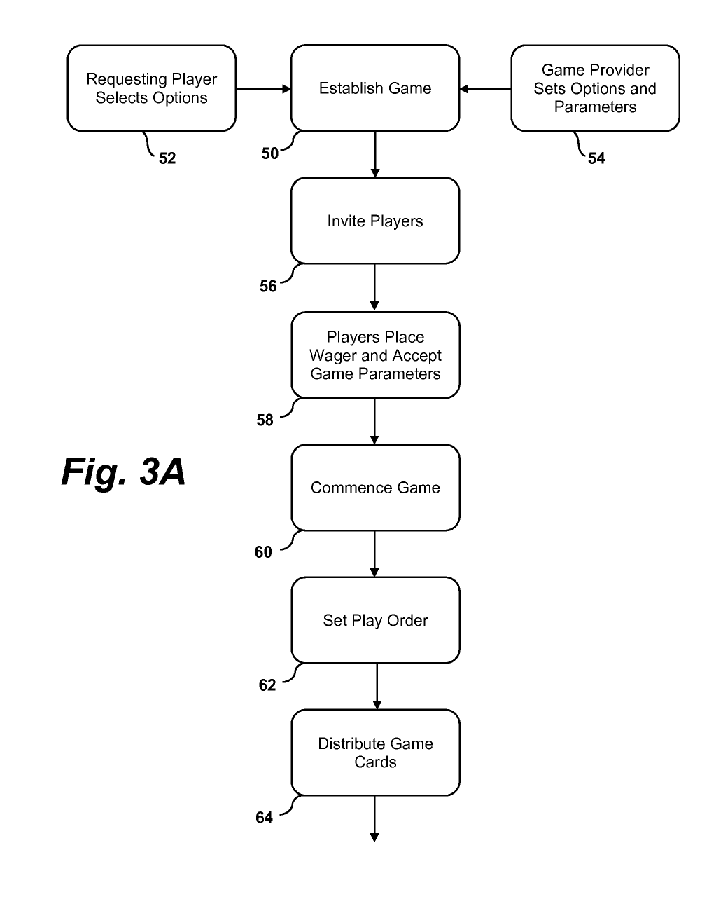

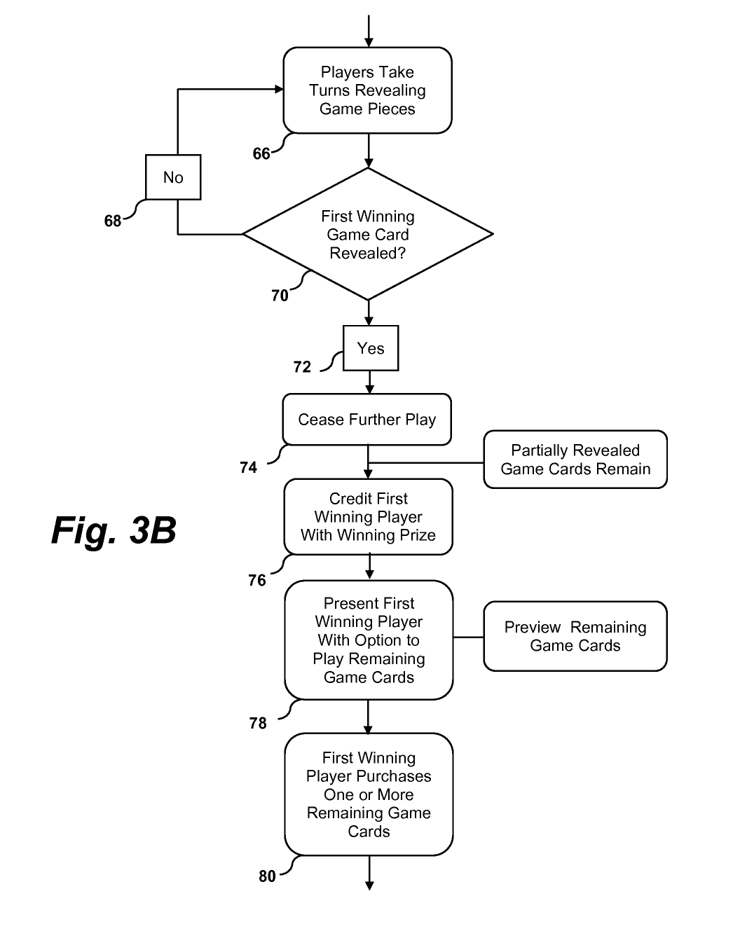

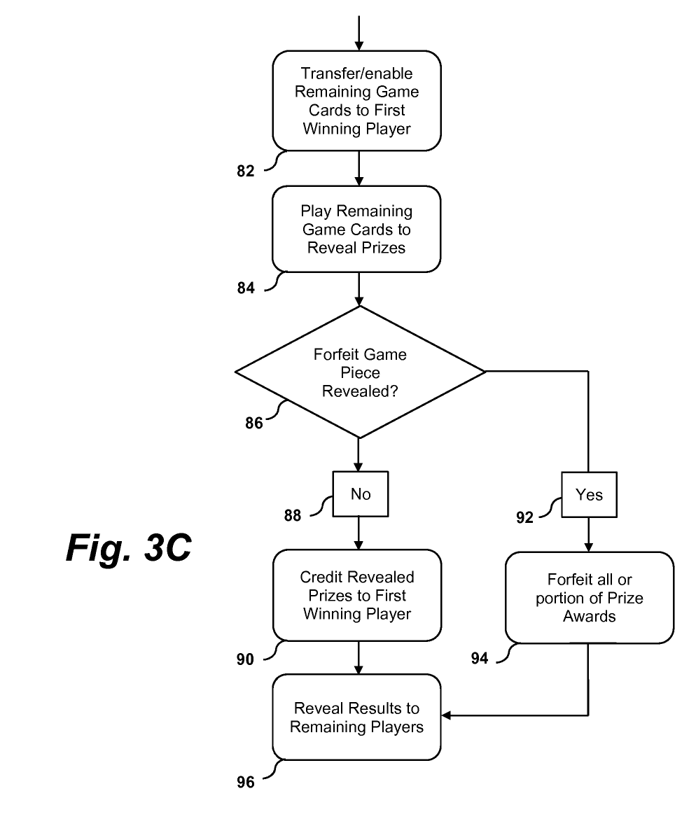

FIGS. 3A through 3C are flow diagrams that depict aspects of certain embodiments of the present gaming methodology. Referring to FIG. 3A, the multi-player game is established at step 50. This may occur in various ways. For example, as discussed above with respect to FIG. 1, a requesting player 24 may contact the game provider via the game website and request that a game be established. The requesting player 24 may request that the game be established for a certain number of players, for example four players. Alternatively, the number of players may be established by the game provider and is not a variable option. There is no requirement that such players be known to one another. The requesting player 24 may be a member of a social network 22 (FIG. 1), with the intent being that other members 26 of the same social network be invited to play in the multi-player game. The requesting player 24 may be provided with a menu of various game options/parameters for incorporation into the requested game. For example, the requesting player may be able to establish the wager amount (and thus the prize awards), number of players, type of game (e.g., game theme), as well as a number of add-on features. For example, these add-on features may include a bonus game for an additional wager amount, the ability to accumulate player loyalty reward points, purchase of prize multipliers, and so forth. It should be appreciated that the game is not limited by any type of additional add-on or bonus features in this regard.

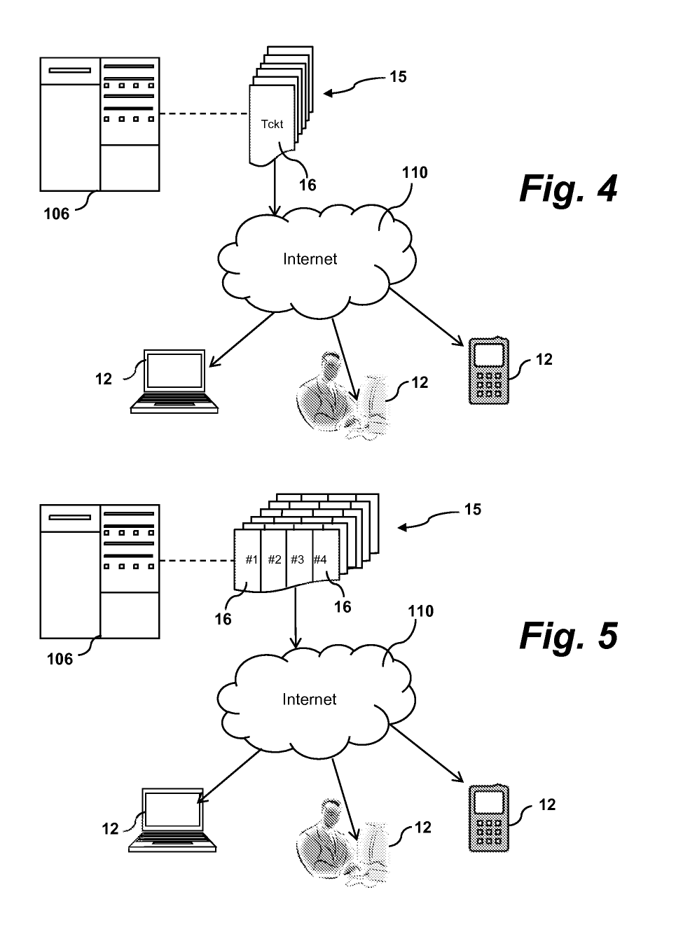

In an alternate embodiment depicted in step 54 in FIG. 3A, the game provider essentially sets all of the play options and parameters, such as number of players, prize awards, game themes, and so forth. Embodiment in accordance with this configuration will be discussed in greater detail below with respect to FIGS. 4 and 5.

Once the game is established, the remaining players are invited to join the game at step 56. This invite may happen in various ways. For example, the requesting player 24 may issue invites to the other members of the social media group 22 (FIG. 1) via any suitable electronic form, such as a text, e-mail, call-out, website notification, and so forth. The invite may include a link to the game provider's website where the game will be ultimately conducted via the respective player's network-enabled devices 12, as discussed above. This link may provide the player's with an access code or the like, wherein upon entry of the code, the players are directed to the particular established game. In an alternate embodiment, the link may take the player's directly to the established multi-player game.

In alternate embodiments discussed above with respect to FIG. 2, the various players may be members or patrons of a gaming establishment, such as a gaming house, casino, bar/grill, and the like, wherein the invites are sent to the plurality of game terminals 104 (FIG. 2). In this particular scenario, any one of the patrons of the establishment may request that a game be established via one of the terminals 104, wherein invites are then directed to all of the remaining terminals. Any player at one of the terminals may join the multi-player game on a first-come basis until the requisite number of players is satisfied.

In still another embodiment, the game provider may establish an ongoing series of “open” games on the game website, wherein a player can access the website and join one of the games. As soon as the requisite number of players joins, the game is commenced. In this particular embodiment, it should be appreciated that the players may be located virtually anywhere subject onto to network connectivity and if applicable, the jurisdictional limits of the lottery authority and such player need not know the identity of the other players. The open game scenario may also be established for patrons of a gaming establishment, as discussed above, wherein players at the gaming establishment join the game on a first-come basis.

Referring again to FIG. 3A, at step 58, once the requisite number of players have registered, the players place their respective initial wager for entry in the game and may be required to make a formal acceptance of the various game parameters that have been established either by the requesting player 24 (FIG. 1) or by the game provider. It should be appreciated that the process for wagering and accepting payment is not a limiting factor of the present invention. Any suitable electronic transfer means may be established. For example, the players may have a pre-established game account wherein these game accounts are separately funded and debited with the wager amount. Prize awards may also be credited to the player's accounts. In alternate embodiments, the players may purchase credits at various authorized lottery retail establishments, wherein the credits include a code for entry by the players when placing their wager for the multi-player game. It should also be appreciated that various measures would be taken to ensure any minimum age and residency requirement of the jurisdiction within which the multi-player game is established. Such measures are well known to those skilled in the art and need not be discussed in detail herein.

Once the wagers have been verified, and any other initial game parameter requirements satisfied, the game commences at step 60. This commencement may include establishing a play order at step 62 for the plurality of players that determines the sequential order in which the players will take turns playing the base game until a first winning player is designated. This play order may be predetermined by the game provider prior to actual commencement of the multi-player game. In an alternate embodiment, the plurality of players may have the option to determine the play order.

After setting the play order (or concurrent therewith), respective game plays are distributed to the players at step 64. For sake of discussion, these game plays are embodied as game cards in the figures. This “distribution” may entail simply providing each player a virtual game card via the game website. The order in which the game cards are assigned may be predetermined by the game provider, and may be linked to the player order. In an alternate embodiment, the players may be simultaneously presented with all of the game cards to be played in the multi-player game, wherein the players select their respective game card according to the defined game order. These events may be conducted via interaction with the players via the game website, with the various selections and choices being displayed to all of the players.

Referring to FIG. 3B, once all of the game cards have been distributed, and the play order established, the game commences by the players taking turns according to the established play order to reveal game pieces hidden on their respective card at step 66.

At this point, it should be appreciated that although the game variables can vary widely within the scope and spirit of the invention, in particular embodiments, essentially all aspects and outcome of the game may be predetermined by the game provider and cannot be influenced by actions of the players, although it may appear to the players through presentation of the game via the website, that the players are actually controlling the outcome of the game. For example, the win/loss status of each of the plurality of game cards may be predetermined by the game provider prior to commencement of the multi-player game. Regardless of the selection of game pieces made by the individual players, the outcome of the particular game cards cannot be changed by any action taken by the player. In other words, although the players are presented with the feel of an interactive, competitive game, in such an embodiment all of the game results are predetermined and cannot be influenced by the player.

However, it should also be appreciated that any number of the game variables may be influenced by the player in other game embodiments that come within the scope and spirit of the invention. For example, although the outcome of each of the individual game cards may be predetermined, the players may decide or select amongst themselves the play order, as well as the particular game cards assigned to particular players.

Referring again to FIG. 3B, the players will continue to take turns according to the assigned play order at steps 68 and 70 until a first winning game card is revealed and the first winning player is identified. For example, in the embodiment wherein the game cards 16 represent virtual scratch-off lottery tickets, the first player to “reveal” a set of game indicia 18 that satisfies a game-winning pattern, number, or other combination of indicia is designated as the first winning player. At this point, further game play ceases at step 74. It should be appreciated that, at this time, one or more of the remaining game cards are in a partially revealed state in which the win/loss outcome of the remaining game cards cannot be determined without further game play.

The first winning player is credited with the winning prize associated with their game card at step 76. For example, the player's account may be credited with the winning prize amount. Alternatively, the player may be issued an award code that the player can take to an authorized redemption center to redeem the prize award. Any manner of providing the player with a means to redeem the winning game card is within the scope and spirit of the invention.

At step 78, the first winning player is presented with the option to pay an additional wager amount for transfer of at least one of the partially revealed remaining game plays for further play by the first winning player. This step may include allowing the first winning player to preview the remaining game plays in their partially revealed state, for example by the game provider server generating the remaining game plays on the first winning player's screen in their respective partially revealed state. In this manner, the first winning player is fully aware of the state of the remaining game plays prior to exercising the option. This option may be for one, all, or any combination of the remaining game plays.

At step 80, the first winning player tenders an additional wager to purchase one or more of the remaining game plays. The amount of this additional wager may vary widely within the scope and spirit of the invention. For example, in one embodiment, this additional wager amount may be determined as a function of the number of remaining game plays transferred to the first winning player, with the player having the option to purchase any one, combination, or all of the remaining game plays. For example, the wager amount per game play for three remaining game plays would be less than the amount per game play for two or one remaining game play. The additional wager amount for each of the remaining game plays may be less than the initial wager amount for the respective game play. For example, the initial wager amount for a game play for each player may be $5, whereas the wager amount for a partially revealed game play may be $3.

In another embodiment, the additional wager amount for each of the remaining game plays may vary as a function of the revealed state of the respective game play. For example, the additional wager amount may increase with a greater revealed state of the respective game play because the player can more readily ascertain the likelihood of a winning play for a more “revealed” game play as compared to a lesser revealed game.

The additional wager amount for the remaining game plays need not be a cash wager, even if the initial wager amount was a cash wager. For example, gaming configurations are known wherein players maintain an account with the gaming authority, particularly for Internet enabled games. The players typically fund the account with a cash transfer, wherein the account is subsequently debited for each play of a lottery game. Awards may be credited to the account. For many such accounts, the players may earn loyalty or bonus points for various lottery related activities, such as for each play of a game, or every time the layer logs on to their account, and so forth. In certain embodiments according to the present invention, the players may be able to purchase the remaining game plays with such bonus or loyalty points.

At step 82, the remaining game plays purchased by the first winning player are transferred (or enabled) for actual play by the first winning player. If the game plays were previously presented to the first winning player to preview, then the games are enabled at this point. If the games were not presented for preview, then they may be transferred and enabled at this point.

At step 84, the first winning player commences to play the purchased remaining plays. In the embodiment wherein the game plays are simulated scratch-off lottery tickets, this would entail simulated removal of the scratch-off layer from the remaining game pieces to reveal whether the card is a winning card and, if so, the amount of the prize award. Any such prize awards associated with the remaining game plays are awarded or credited to the first winning player.

It should be appreciated that the prize award in any one of the remaining game plays is not restricted or limited by the prize award of the first winning player's game play. For example, the remaining game play prize awards may be greater than the first winning player's initial prize award, or may not be a cash award. For example, the prize award in any of the remaining game plays may be merchandise, services, or any other non-cash award.

In an embodiment represented by steps 86 through 94 in FIG. 3C, the possibility exists that at least one of the remaining game plays includes a hidden “forfeit” game piece or other type of icon that, if revealed by the first winning player upon further play or the game, results in the first winning player forfeiting all or a portion the player's prize award. For example, the forfeit game piece may result in loss of the first winning player's initial prize award, or forfeiture of the additional prize awards, or forfeiture of both the initial prize and award and the additional prize awards (or a portion of either or both prize awards).

The outcome and prize award of the partially revealed game cards need not be revealed to the respective remaining players. In this manner, the remaining players do not know the prize award that may have been associated with their respective game card that was transferred to the first winning player. The remaining players may not be notified of the identity of the first winning player.

In an alternate embodiment depicted at step 96 in FIG. 3C, the outcome and prize award of the partially revealed game cards is revealed to the remaining players upon termination of the game. In this manner, each of the players is made aware of the prize award that was associated with their respective game card. In a variation of this particular embodiment, the outcome and prize awards of all of the remaining game cards are revealed to all of the remaining players so that each of the players knows the total value of all of the prize awards won by the first winning player, as well as the particular awards for each respective game card. Thus, in this particular embodiment, the players are made aware of the fact that the prize award associated with the game card for the first winning player may have been significantly less than other prize awards associated with the remaining game cards. For example, the prize award for the game card assigned to the first winning player may be $10, whereas the prize award for one of the remaining game cards may be $100. Assuming the first winning player elects to purchase one or more of the remaining game cards, he is awarded all of the prize awards associated with those purchased remaining game cards due to the fact that he is designated as the “first” winning player.

FIG. 4 depicts an exemplary system embodiment that may be used to implement certain aspects of the game methodologies. As discussed above, the game provider may utilize a server 106 that communicates with the individual players' network-enabled devices 12 via any suitably configured network, such as the Internet 110. The server 106 includes a database 15 of individual files or records that emulate a production run of individual scratch-off lottery tickets 16. As is understood by those skilled in the art, a game provider/manufacturer of scratch-off lottery tickets establishes the probability of winning and payout percentage over an entire production run of tickets as a function of the number of tickets sold. The outcome and any prize award of each ticket are predetermined. FIG. 4 depicts an embodiment that emulates an electronic production run of scratch-off lottery tickets, with each ticket stored as an electronic file. For play of the multi-player game in accordance with aspects of the invention, the tickets are essentially distributed to the players in a sequential order. The file 15 may be “seeded” with winning tickets 16 at defined intervals, for example every sequential group of ten tickets may have two or three winning tickets of varying prize award values to ensure that a game of ten players has at least one first winning ticket and one additional remaining game play winner. The ten tickets could be randomly distributed to the players to prevent the players from jockeying for a perceived advantage. Once the database 15 of tickets 16 is at or near exhaustion, another database 15 is made available for future multi-player games.

FIG. 5 depicts an alternate embodiment wherein each file in the database 15 includes a defined number of simulated tickets 16, for example four tickets as depicted in FIG. 5. With this configuration, each multiplayer game would have four players, with the four tickets 16 being distributed to the four players (randomly or by the randomly determined play order wherein the first randomly determined player receives ticket #1, the second randomly determined player receives ticket #2, and so forth). With this arrangement, the game provider has control various aspects of the game. For example, the game provider can control the order in which the tickets are played, which ticket will be the first winning ticket (and respective prize award), the partially revealed state of the remaining tickets (and respective prize awards) regardless of how the player plays the card, and so forth. For example, the first group of ticket files 16 may be scripted (e.g., software commands) such that, regardless of player interaction, ticket #2 will be the first winning ticket and will be revealed at the third reveal step and has a prize award of $10, ticket #1 will have two game pieces revealed and will have a remaining hidden prize award of $5, ticket #3 will have two game pieces revealed and a hidden forfeit game piece, and ticket #4 will have two game pieces revealed and no prize award. The first winning player has certain “controls” in the game in that he may opt to only purchase remaining ticket # 4, in which case the prize award of remaining ticket #5 goes “unrewarded” and the forfeit game piece of remaining ticket #3 does not harm the first winning player.

Thus far, all of the above examples contemplate that at least one game card in any given base game must contain at least one winning game card to be awarded to the first winning player. It should be understood that in some embodiments, a winning game card need not be present in any given game. This may be a desirable feature for some games where the prize payout must be structured over a multiplicity of game plays, thus correlating these game plays to an entire production run of tickets as a function of the number of tickets sold.

It should be appreciated by those skilled in the art that various modifications and variations may be made present invention without departing from the scope and spirit of the invention. It is intended that the present invention include such modifications and variations as come within the scope of the appended claims.

What is claimed is:

1. A computer-enabled method for implementing a network-based multi-player participation game with increased revenue generation potential, comprising:
providing for a plurality of players to access a website via a network enabled device and join a multi-player game hosted over the network by a game provider via a host computer;
for an initial wager amount from each player, assigning to each player an individual virtual game play, the prize award and game outcome of each respective game play being hidden from the player;
assigning a play order to the plurality of players, wherein the players take turns revealing an aspect of the outcome of their respective game play according to the assigned play order;
upon a first one of the players revealing a winning game outcome of their game play during one of their respective turns, ceasing further play of the multi-player game and awarding to the first winning player the prize award assigned to their game play, wherein one or more of the remaining game plays of the other players are in a partially revealed state;
providing an option to the first winning player to pay an additional wager amount for transfer of at least one of the remaining game plays for further play by the first winning player; and
awarding to the first winning player all prize awards for the remaining game plays transferred to the first winning player.

2. The method as in claim 1, wherein the additional wager amount is a function of the number of remaining game plays transferred to the first winning player, with the first winning player having the option to transfer any combination or all of the remaining game plays.

3. The method as in claim 2, wherein the additional wager amount for each of the remaining game plays is less than the initial wager amount for the respective game play.

4. The method as in claim 1, wherein the additional wager amount for each of the remaining game plays is a function of the revealed state of the respective game play.

5. The method as in claim 4, wherein the additional wager amount increases with a greater revealed state of the respective game play.

6. The method as in claim 1, wherein the additional wager amount is a cash amount.

7. The method as in claim 1, wherein the additional wager amount is a point value debited against a player's account.

8. The method as in claim 1, wherein the first winning player is not guaranteed that any of the partially revealed game plays includes a prize award.

9. The method as in claim 1, wherein the first winning player is guaranteed that at least one of the partially revealed game plays includes a prize award.

10. The method as in claim 1, wherein at least one of the partially revealed game plays includes a prize award that is greater than the prize award for the first winning player's game play.

11. The method as in claim 1, wherein at least one of the partially revealed game plays includes a hidden forfeit game piece that, if revealed by the first winning player, results in loss of at least a portion of the first winning player's prize awards.

12. The method as in claim 1, wherein the game plays are virtual game cards implementing a simulated scratch-off lottery ticket, each of the game cards having a plurality of game pieces covered by a simulated scratch-off layer, the game pieces determining a win/loss status and prize award for the game card, the plurality of players taking turns revealing game pieces on their respective game cards until the first winning player reveals a game piece during their respective turn that establishes their game card as the first winning game card.

13. The method as in claim 12, wherein the prize award of the partially revealed game cards are not revealed to the remaining players such that the remaining players do not know the prize award associated with their respective game card that was transferred to the first winning player.

14. The method as in claim 12, wherein the prize award of the partially revealed game cards is revealed to the remaining players such that the remaining players are aware of the prize award associated with their respective game card that was transferred to the first winning player.

15. The method as in claim 14, wherein the prize awards of all of the remaining game cards are revealed to all of the remaining players so that each of the plurality of players knows the total value of all prize awards won by the first winning player and the prize award for each respective game card.

16. The method as in claim 1, wherein the network is the Internet and the plurality of players are members of an Internet social media group, the plurality of players invited to participate in the multi-player game by an invite distributed via the Internet social media group.

17. The method as in claim 16, wherein a requesting member of the social media group initiates the multi-player game with a request made to the game provider and transmits the invites to other members of the social media group, the requesting member provided with options to configure the multi-player game, and wherein the other members of the social media group must accept the options selected by the requesting member prior to start of the multi-player game.

18. The method as in claim 1, wherein the network is a local area network within a gaming establishment, and the plurality of players are patrons of the gaming establishment, and wherein the network enabled devices are terminals provided to the patrons at the gaming establishment.

19. The method as in claim 1, wherein any one or combination of the following are predetermined by the game provider prior to commencement of the multi-player game: win/loss status of each of the plurality of game plays; the play order for the plurality of players; and the game play for the first winning player.

20. The method as in claim 1, wherein a win/loss status of each of the plurality of game plays is predetermined by the game provider prior to commencement of the multi-player game, and wherein each of the plurality of players chooses their respective game play from a collection of the game plays according to the play order.

21. The method as in claim 1, wherein there exists a finite number of game plays available for initial wager and a finite value of all prize awards associated therewith, wherein the additional wager amounts obtained from the first winning player serve increase total game revenue to the game provider above that associated with the initial wager amount.
